(19) United States
(12) Patent Application Publication
(10) Pub. No.: US 2014/0193735 A1
(43) Pub. Date: Jul. 10, 2014

(54) Low Vibration Linear Motor Systems

(71) Applicant: LILLIPUTIAN SYSTEMS, INC., Wilmington, MA (US)

(72) Inventor: Samuel B. Schaevitz, Concord, MA (US)

(73) Assignee: LILLIPUTIAN SYSTEMS, INC., Wilmington, MA (US)

(21) Appl. No.: 13/734,888

(22) Filed: Jan. 4, 2013

(51) Int. Cl. H01M 8/04; H02P 23/00

(52) U.S. Cl. CPC H01M 8/04089; H02P 23/00
USPC 429/444; 318/503

(57) ABSTRACT

A portable fuel cell system includes a fuel cell having a fluid path, a pump having a pumping chamber disposed in the fluid path and a mechanical input, an electric motor having a power signal input and having an oscillatory mechanical output coupled to the mechanical input, the mechanical output having unwanted vibration primarily at a first drive frequency of a power signal, a spring and mass assembly coupled to the mechanical output so as to vibrate out of phase with, and to reduce the unwanted vibration of, the mechanical output at the drive frequency, a vibration transducer physically coupled to the mechanical output and having a vibration transducer signal output, and an electrical control system having an input coupled to receive the vibration transducer signal output and having a control output coupled to the power signal input.

### CROSS REFERENCE TO RELATED APPLICATIONS

The present application is related to U.S. patent application entitled FUEL CELL SYSTEMS AND RELATED METHODS, Attorney Docket No. 3553/138, filed on Jan. 4, 2013, U.S. patent application entitled A FUEL CELL SYSTEM HAVING AN AIR QUALITY SENSOR SUITE, Attorney Docket No. 3553/139, filed on Jan. 4, 2013, U.S. patent application entitled FUEL CELL SYSTEM HAVING A PUMP AND RELATED METHOD, Attorney Docket No. 3553/141, filed on Jan. 4, 2013, U.S. patent application entitled A FUEL CELL SYSTEM HAVING WATER VAPOR CONDENSATION PROTECTION, Attorney Docket No. 3553/142, filed on Jan. 4, 2013, U.S. patent application entitled A FUEL CELL SYSTEM HAVING A SAFETY MODE, Attorney Docket No. 3553/143, filed on Jan. 4, 2013, U.S. patent application entitled A PORTABLE FUEL CELL SYSTEM HAVING A FUEL CELL SYSTEM CONTROLLER, Attorney Docket No. 3553/144, filed on Jan. 4, 2013, and U.S. patent application entitled A METHOD FOR BONDING SUBSTRATES, Attorney Docket No. 3553/145, filed on Jan. 4, 2013, the disclosures of which are incorporated by reference herein in their entirety.

### TECHNICAL FIELD

The present invention relates to linear reciprocating motors, and more particularly to low vibration linear motor systems that may be used within portable fuel cell systems.

### BACKGROUND ART

Fuel cells produce electricity from chemical reactions. The chemical reactions typically cause a fuel, such as hydrogen, to react with air/oxygen as reactants to produce water vapor as a primary by-product. The hydrogen can be provided directly, in the form of hydrogen gas or liquid, or can be produced from other materials, such as hydrocarbon liquids or gases. Fuel cell assemblies may include one or more fuel cells in a fuel cell housing that is coupled with a fuel canister containing the hydrogen and/or hydrocarbons. Fuel cell housings that are portable coupled with fuel canisters that are portable, replaceable, and/or refillable, compete with batteries as a preferred electricity source to power a wide array of portable consumer electronics products, such as cell phones and personal digital assistants. The competitiveness of these fuel cell assemblies when compared to batteries depends on a number of factors, including their size, cost, efficiency, and reliability.

In a high temperature fuel cell system, such as a solid oxide fuel cell (SOFC) system, an oxidizing flow is passed through the cathode side of the fuel cell while a reducing flow is passed through the anode side of the fuel cell. The oxidizing flow is typically air, while the reducing flow typically comprises a mixture of a hydrogen-rich gas created by reforming a hydrocarbon fuel source and water vapor. The fuel cell, typically operating at a temperature between 650° C. and 850° C., enables the transport of negatively charged oxygen ions from the cathode flow stream to the anode flow stream, where the ions combine with either free hydrogen or hydrogen in a hydrocarbon molecule to form water vapor and/or combine with carbon monoxide to form carbon dioxide. The excess electrons from the negatively charged ions are routed back to the cathode side of the fuel cell through an electrical circuit completed between the anode and the cathode, resulting in an electrical current flow through the circuit.

One or more pumps or pressurized sources located upstream of the fuel cell are typically used in a fuel cell system, in the fluid path thereof, to separately transport oxygen and fuel flows into the fuel cell. For portable fuel cell applications, the pump needs to be miniaturized, energy efficient, and low vibration. Excessive vibration of the pump is unpleasant when the users hold the device, and can result in excessive noise due to vibrating against other objects.

Thus, there is a need to provide pumps for portable fuel cell systems which are small, energy efficient and low vibration. In other fields as well, there is a need for systems with oscillatory motors which are small, energy efficient and low vibration.

### SUMMARY OF THE EMBODIMENTS

In one embodiment of the invention, a portable fuel cell system having a low vibration linear motor assembly includes a fuel cell having a fluid path including an intake and an exhaust, a pump having a pumping chamber disposed in the fluid path and a mechanical input, an electric motor, having a power signal input, the power signal input being removably connectable to an electrical power source, and having an oscillatory mechanical output coupled to the mechanical input of the pump, the mechanical output having unwanted vibration primarily at a first drive frequency of a power signal at the power signal input. The system further includes a spring and mass assembly configured to have a resonance at the drive frequency and coupled to the mechanical output of the motor so as to vibrate out of phase with the mechanical output of the motor at the drive frequency and so as to reduce the unwanted vibration of the mechanical output at the drive frequency, a vibration transducer, physically coupled to the mechanical output of the motor, and having a vibration transducer signal output, and an electrical control system having an input coupled to receive the vibration transducer signal output and having a control output coupled to the power signal input of the motor. The control system is configured so that the control output causes a reduction in vibration of the mechanical output of the motor at least one harmonic of the drive frequency.

In related embodiments, the pump may further include a diaphragm disposed over a pumping chamber, and the oscillatory mechanical output of the motor may be coupled to the diaphragm. The vibration transducer may include an accelerometer. The control output may include a first control frequency component having a first control frequency magnitude and a first control frequency phase, the first control frequency component configured to be an integral harmonic of the drive frequency, and the control system is configured to adjust the first control frequency magnitude and first control frequency phase to reduce the vibration of the mechanical output at the first control frequency. The control output may further include a second control frequency component having a second control frequency magnitude and a second control frequency phase, wherein the second control frequency component is an integral harmonic of the drive frequency that is not the same as the harmonic of the first control frequency component, and wherein the electrical control system is configured to modulate the second control frequency magnitude and second control phase to reduce vibration of the mechanical output at the second control frequency. The electrical control system may be further configured to modulate the drive frequency in response to the vibration transducer signal output to minimize vibration measured by such signal output.

In another embodiment of the invention, an electrically powered system includes an electric motor having a power signal input, the power signal input being removably connectable to an electrical power source, and having an oscillatory mechanical output coupled to a load, the mechanical output having unwanted vibration primarily at a first drive frequency of a power signal at the power signal input. The system further includes a spring and mass assembly configured to have a resonance at the drive frequency and coupled to the mechanical output of the motor so as to vibrate out of phase with the mechanical output of the motor at the drive frequency and so as to reduce the unwanted vibration of the mechanical output at the drive frequency. The system also includes a vibration transducer, physically coupled to the mechanical output of the motor, and having a vibration transducer signal output and an electrical control system having an input coupled to receive the vibration transducer signal output and having a control output coupled to the power signal input of the motor. The control system is configured so that the control output causes a reduction in vibration of the mechanical output of the motor at one or more harmonics of the drive frequency.

In related embodiments, the vibration transducer may include an accelerometer. The control output may include a first control frequency component having a first control frequency magnitude and a first control frequency phase, the first control frequency component configured to be an integral harmonic of the drive frequency, and the control system is configured to adjust the first control frequency magnitude and first control frequency phase to reduce the vibration of the mechanical output at the first control frequency. The control output may further include a second control frequency component having a second control frequency magnitude and a second control frequency phase, wherein the second control frequency component is an integral harmonic of the drive frequency that is not the same as the harmonic of the first control frequency component, and wherein the electrical control system is configured to modulate the second control frequency magnitude and second control phase to reduce vibration of the mechanical output at the second control frequency. The electrical control system may be further configured to modulate the drive frequency in response to the vibration transducer signal output to minimize vibration measured by such signal output.

### BRIEF DESCRIPTION OF THE DRAWINGS

The foregoing features of embodiments will be more readily understood by reference to the following detailed description, taken with reference to the accompanying drawings, in which:

FIG. 1 is a schematic diagram of a portable fuel cell system according to an illustrative embodiment of the present invention.

FIG. 2 is a graph showing data of vibration energy in a surrounding device at a drive frequency, a first harmonic of the drive frequency and a second harmonic of the drive frequency according to an illustrative embodiment of the present invention.

### DETAILED DESCRIPTION OF SPECIFIC EMBODIMENTS

### Definitions

As used in this description and the accompanying claims, the following terms shall have the meanings indicated, unless the context otherwise requires:

A “spring” is a general term to refer to any mechanical assembly which provides force in opposition to displacement.

A “mass” is a general term to refer to any mechanical assembly with inertia.

A “spring-mass assembly” is a general term to refer to any mechanical assembly employing a spring coupled to a mass so has to exhibit resonance at some frequency, and includes an assembly in which the mass and the spring are not distinct entities.

A motor with an “oscillatory output” is a motor that produces a mechanical output moving in an approximately periodic fashion.

A “fuel cell” is any portion of the system containing at least part of the electrochemical conversion structures, including an anode, electrolyte and cathode, and also including portions of the housings, flow conduits, electronics, and other associated peripheral components coupled to the electrochemical structures.

Prior art vibration reduction systems include passive vibration isolators. Passive vibration isolators consist of some form of mechanical isolation between the oscillatory motor system and the surrounding device. This isolation may take the form of rubber feet, foam padding, or more complex designed mechanical suspensions with specific frequency response characteristics. In all cases, they function by allowing the oscillatory motor system to vibrate while minimizing the force that vibration applies to the surrounding device. In order to improve the effectiveness of passive vibration isolators, they must be made very soft. In order to have both a very soft isolator and a significant force resistance, the isolator must also be made very large.

We have found the use of passive isolators is insufficient to reduce the vibration transmitted into the surrounding device to an acceptable level in many applications. In particular, portable applications require a compact device which is often held by a user. In these cases, the user is very sensitive to even low level vibrations. In order to reduce the vibrations to those levels, the passive isolator must be very soft. However, a very soft isolator is insufficient to prevent the oscillatory motor system from contacting the surrounding device during shock events, such as dropping of the system. In some cases, the required softness would not allow an orientation independent system because turning the system over would exceed the force that the isolator can withstand.

Other prior art vibration reduction systems include active vibration isolators. Active vibration isolators are similar to passive vibration isolators, in that they are also located between the oscillatory motor and the surrounding system, but they further include some mechanism to controllably apply force to the oscillatory motor system. By applying a small amount of force at the right frequency and phase, the active vibration isolator is able to further reduce the force that the vibrating oscillatory motor system applies to the surrounding device. This may function by reducing the effective spring constant of the isolator, or it may function by damping out excessive resonant motion of the oscillatory motor system. Limited effectiveness can be achieved with self-powered active isolators which store and release energy provided by the oscillatory motor system. To enable high effectiveness, the active isolator must include a significant motor system itself and the significant size, power and cost impact that requires.

Active vibration cancellation is similar to active vibration isolators, but the oscillatory motor is attached to an additional “auxiliary mass”, which is actively driven in opposition to the vibrations produced by the oscillatory motor. This approach allows the vibration cancellation to be mounted elsewhere on the device instead of between the motor and the surrounding device, but otherwise requires similar high power, and even larger size because of the additional mass required.

For small portable fuel cell systems, the large size and significant power losses associated with these prior art active isolators and cancellation degrade the efficiency of the system. Often this results in an unacceptable system performance.

Some vibration reduction prior art includes dynamic vibrators. The dynamic vibrator consists of a mass and a spring which are constructed such that the dynamic vibrator has a resonant frequency which closely matches the frequency of operation of the oscillatory motor. When the oscillatory motor moves at that frequency, the resulting vibrations cause the dynamic vibrator to move in the opposite direction. With proper construction in a simple sinusoidal system, the motion of the dynamic vibrator can almost perfectly cancel the motion of the oscillatory motor, resulting in little net vibration on the surrounding device. However, any particular dynamic vibrator is only highly effective at one very narrow frequency. The frequency range can be broadened by adding in damping to the dynamic vibrator, but that also results in reduced vibration cancellation effectiveness.

The above description of existing vibration reduction techniques is intended to provide exemplars of the prior art. The prior art contains a very broad group of variations on the above methods and devices, combinations thereof, and additional methods not described herein. However, all of the prior art suffers from some combination of limited effectiveness, narrow frequency effectiveness, and large size, power and cost. Embodiments of the present invention provide an improved vibration isolation system for fuel cell pumps with high effectiveness over many frequencies, with reduced size, power and cost.

We have found that the use of a dynamic vibrator (a spring-mass assembly) is effective at eliminating vibration at the drive frequency of fuel cell pumping system using an oscillatory motor, but there exists significant vibration energy at other frequencies. In particular, the frequencies which are integer multiples of the primary vibration frequency, known as harmonics, often contain significant vibration energy. The energy may be primarily contained in one harmonic, such as the frequency, which is exactly double the primary vibration frequency. In other pumping systems, there may be significant energy contained in multiple harmonics, such as the frequencies which are exactly double and triple the primary vibration frequency. Other multiples are also observed.

Embodiments of the present invention can reduce the impact of both the primary and harmonic vibrations with high effectiveness by combining the dynamic vibrator to eliminate the primary vibration frequency with an active vibration cancellation system using a vibration transducer and an additional control signal to the existing oscillatory motor contained in the fuel cell pump to identify and produce the correct vibration cancellation motion. By reusing the existing oscillatory motor, embodiments of the present invention are able to produce a system with little added size or mass.

We have also found that in many applications, the overall power consumption of this system is not substantially increased compared to the power used without the active vibration cancellation signal. In some cases, the overall power consumption of the system is actually reduced by the application of the active vibration cancellation signal. This unexpected result is likely due to the nature of the work performed by the oscillatory motor. Many applications utilize the primary oscillation frequency of the oscillatory motor to do the primary work, while the higher harmonics do not do useful work and may even detract from the useful work. By reducing or eliminating the higher harmonic motions at the source, the oscillatory motor, the active vibration cancellation system also reduces these losses in the system.

Embodiments of the present invention provide an improved portable fuel cell system. Other embodiments of the invention can also be applied to other oscillatory motor systems where there is a very high premium on small size and low power operation.

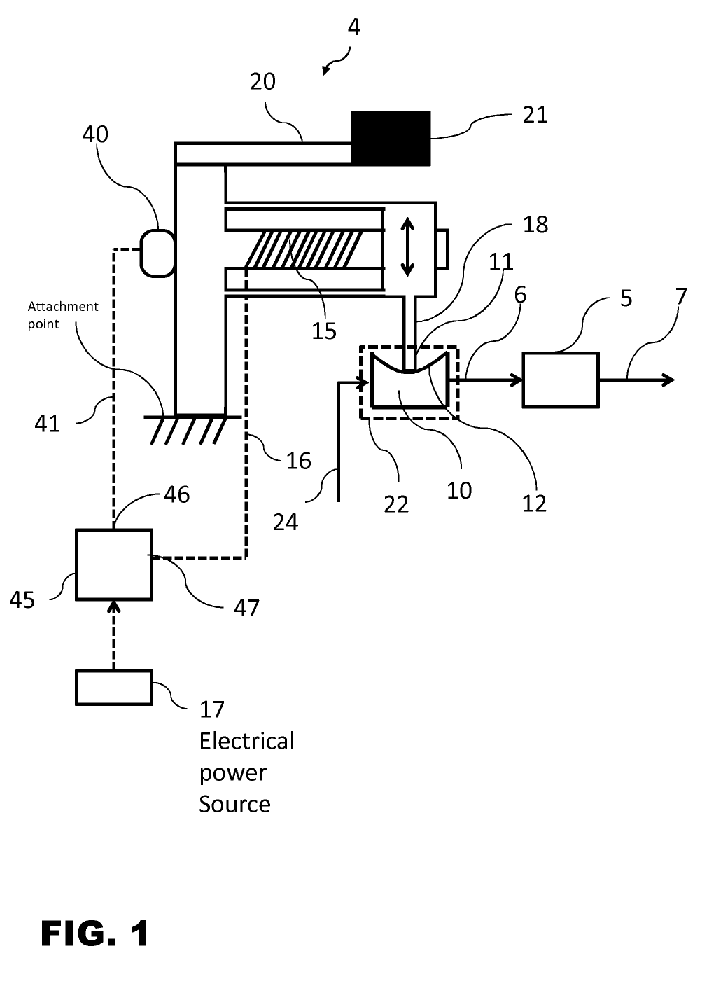

FIG. 1 illustrates a portable fuel cell system 4, according to one embodiment of the present invention. The fuel cell system 4 includes a fuel cell 5, having a fluidic path including an intake 6 and an exhaust 7. The fuel cell system 4 further includes a pump 22 having a pumping chamber 10, disposed in the fluidic path of the fuel cell 5, having a mechanical input 11. The pump 22 may include a pump input 24. Additionally, the fuel cell system 5 includes an electrical motor 15 having a power input signal 16, wherein the power signal 16 is removably coupled to a power source 17. The electric motor 15 further has an oscillatory mechanical output 18 coupling the motor 15 to pumping chamber 10 mechanical input 11. The mechanical input 11 is coupled to a diaphragm 12 configured so as to convert the oscillating mechanical motion of the electric motor 15 into fluidic movement in the pumping chamber 10. The fuel cell system 4 further includes a spring 20 and a mass 21 configured to have a resonance at the drive frequency of the electric motor 15, the spring 20 and mass 21 coupled to the motor 15 so as to vibrate out of phase with the mechanical output 18 of the motor 15. The out of phase vibration reduces the power of the vibration transferred from the electrical motor 15 to the fuel cell system 4. Furthermore, the fuel cell system 4 includes a vibration transducer 40 coupled to the mechanical output 18 of the motor 15 and has a vibration transducer signal output 41. The vibration transducer output 41 is coupled to electrical control system 45 having an input 46. The control system 45 is configured to have an output 47 coupled to the power input 16 of the motor 16. The electrical control system 45 is configured so that the control output 47 causes a reduction in vibration of the mechanical output 18 of the motor 15 at least one harmonic of the drive frequency.

In a related embodiment, the pump 22 further includes a diaphragm 12 disposed over the pumping chamber 10, and the oscillatory mechanical output 18 of the pump 22 is coupled to the diaphragm 12, as shown in FIG. 1.

In some embodiments, the vibration transducer 40 may include an accelerometer. According to some embodiments, the control output 47 may include a first control frequency component, such component may have a first control frequency magnitude and a first control frequency phase. The first control frequency component is configured to be an integral harmonic of the drive frequency, and the control system 45 is configured to adjust the first control frequency magnitude and first control frequency phase to reduce the vibration of the mechanical output 18 at the first control frequency. The control output 47 may further include a second control frequency component having a second control frequency magnitude and a second control frequency phase, wherein the second control frequency component is an integral harmonic of the drive frequency that is not the same as the harmonic of the first control frequency component, and wherein the electrical control system 45 is configured to modulate the second control frequency magnitude and second control phase to reduce vibration of the mechanical output 18 at the second control frequency. In some related embodiments, the control system 45 can be further configured to modulate the drive frequency in response to the vibration measurement device to minimize the vibration measured.

The control signal, in some embodiments, can be a synthetically created sinusoidal wave composed of the drive frequency and higher frequency harmonics. Each signal can have phases and amplitude control. In other embodiments, the control signal can be a pulse width modulated square wave that contains the drive and harmonic frequencies. There are numerous other methods of creating a drive signal known to someone skilled in the art.

There are several ways the control signal, as described above, can be adapted to minimize the vibration measured. One possible embodiment is to use a high bandwidth feedback signal from the integrated vibration transducer, this signal can be used to create a cancellation signal that is out of phase with the unwanted vibration signal. This cancellation signal actively nulls the vibration energy that would be otherwise transferred to the surrounding system.

In other embodiments, the control signal design can take advantage of the a priori knowledge of the expected frequencies of this vibration energy. The control system can consist of a small number of discrete sinusoidal signals combined together. Each discrete sinusoid will have a magnitude and a phase which are independently optimized to reduce the vibration measured. In some cases, the vibration measured can be filtered to produce a frequency specific vibration measurement to improve the optimization of a matching control signal frequency. This filtering can be done using analog electronic or digital electronics. As an example, the digital filtering could consist of a Discrete Fourier Transform (DFT) or a simplified frequency filtering algorithm such as the Goertzel algorithm. The corresponding drive signal components at the frequency measured by the filtered signal can then be tuned to reduce vibration at the filtered frequency. In a preferred embodiment, power at the drive frequency, the first integer harmonic and the second integer harmonic are measured. Alternatively, the total energy of the vibration signal can be measured and drive and harmonic portions of the control signal can be adjusted to decrease the total power of this vibration signal.

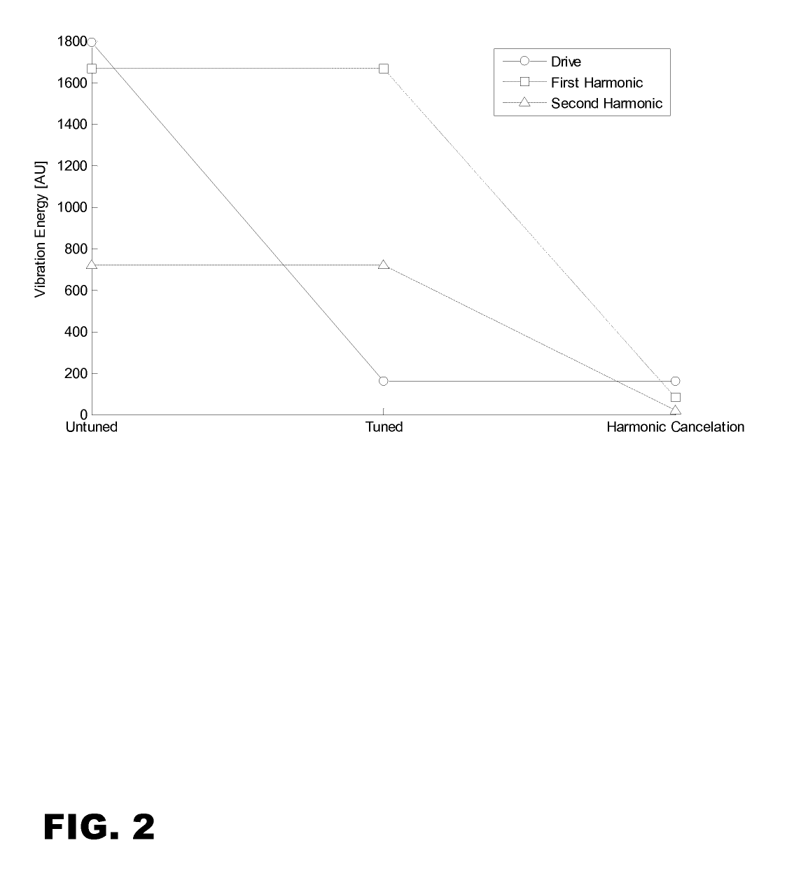

FIG. 2 is a graph which shows data of vibration energy in the surrounding device at the drive frequency, the first harmonic of the drive frequency and the second harmonic of the drive frequency for one constructed embodiment of the disclosed invention. In the un-tuned case, vibration energy is coupled to the system at the drive frequency, the first harmonic of the drive frequency and the second harmonic of the drive frequency. Tuning the drive frequency to match the resonant frequency of the spring and mass assembly cause a significant decrease in the coupled vibration energy at the drive frequency. In the constructed embodiment the vibration energy in the surrounding system was decreased to 1/11th of its un-tuned value measured in arbitrary units (AU). The first and second harmonic energy is not affected by the tuning of the drive frequency. By enabling harmonic cancelation in the control signal, the present invention is able to reduce the coupled energy into the surrounding system by 20× for the first harmonic and 42× for the second harmonic.

The embodiments of the invention described above are intended to be merely exemplary; numerous variations and modifications will be apparent to those skilled in the art. All such variations and modifications are intended to be within the scope of the present invention as defined in any appended claims. For example, although some features may be included in some embodiments and drawings and not in others, these features may be combined with any of the other features in accordance with embodiments of the invention as would be readily apparent to those skilled in the art based on the teachings herein.

What is claimed is:

1. A portable fuel cell system comprising:
a fuel cell having a fluid path including an intake and an exhaust;
a pump having a pumping chamber disposed in the fluid path and a mechanical input;
an electric motor, having a power signal input, the power signal input being removably connectable to an electrical power source, and having an oscillatory mechanical output coupled to the mechanical input of the pump, the mechanical output having unwanted vibration primarily at a first drive frequency of a power signal at the power signal input;
a spring and mass assembly configured to have a resonance at the drive frequency and coupled to the mechanical output of the motor so as to vibrate out of phase with the mechanical output of the motor at the drive frequency and so as to reduce the unwanted vibration of the mechanical output at the drive frequency;
a vibration transducer, physically coupled to the mechanical output of the motor, and having a vibration transducer signal output; and,
an electrical control system having an input coupled to receive the vibration transducer signal output and having a control output coupled to the power signal input of the motor;
wherein the control system is configured so that the control output causes a reduction in vibration of the mechanical output of the motor at least one harmonic of the drive frequency.

2. A portable fuel cell system according to claim 1, wherein the pump further comprises a diaphragm disposed over a pumping chamber, and wherein the oscillatory mechanical output of the motor is coupled to the diaphragm.

3. A portable fuel cell system according to claim 1, wherein the vibration transducer comprises an accelerometer.

4. A portable fuel cell system according to claim 1, wherein the control output comprises a first control frequency component, such component having a first control frequency magnitude and a first control frequency phase, the first control frequency component configured to be an integral harmonic of the drive frequency, and wherein the control system is configured to adjust the first control frequency magnitude and first control frequency phase to reduce the vibration of the mechanical output at the first control frequency.

5. A portable fuel cell system according to claim 4, the control output further comprising a second control frequency component having a second control frequency magnitude and a second control frequency phase, wherein the second control frequency component is an integral harmonic of the drive frequency that is not the same as the harmonic of the first control frequency component, and wherein the electrical control system is configured to modulate the second control frequency magnitude and second control phase to reduce vibration of the mechanical output at the second control frequency.

6. A portable fuel cell system according to claim 1, wherein the electrical control system is further configured to modulate the drive frequency in response to the vibration transducer signal output to minimize vibration measured by such signal output.

7. An electrically powered system comprising:
an electric motor, having a power signal input, the power signal input being removably connectable to an electrical power source, and having an oscillatory mechanical output coupled to a load, the mechanical output having unwanted vibration primarily at a first drive frequency of a power signal at the power signal input;
a spring and mass assembly configured to have a resonance at the drive frequency and coupled to the mechanical output of the motor so as to vibrate out of phase with the mechanical output of the motor at the drive frequency and so as to reduce the unwanted vibration of the mechanical output at the drive frequency;
a vibration transducer, physically coupled to the mechanical output of the motor, and having a vibration transducer signal output; and,
an electrical control system having an input coupled to receive the vibration transducer signal output and having a control output coupled to the power signal input of the motor;
wherein the control system is configured so that the control output causes a reduction in vibration of the mechanical output of the motor at one or more harmonics of the drive frequency.

8. An electrically powered system according to claim 7, wherein the vibration transducer comprises an accelerometer.

9. An electrically powered system according to claim 7, wherein the control output comprises a first control frequency component, such component having a first control frequency magnitude and a first control frequency phase, the first control frequency component configured to be an integral harmonic of the drive frequency, and wherein the control system is configured to adjust the first control frequency magnitude and first control frequency phase to reduce the vibration of the mechanical output at the first control frequency.

10. An electrically powered system according to claim 9, the control output further comprising a second control frequency component having a second control frequency magnitude and a second control frequency phase, wherein the second control frequency component is an integral harmonic of the drive frequency that is not the same as the harmonic of the first control frequency component, and wherein the electrical control system is configured to modulate the second control frequency magnitude and second control phase to reduce vibration of the mechanical output at the second control frequency.

11. An electrically powered system according to claim 7, wherein the electrical control system is further configured to modulate the drive frequency in response to the vibration transducer signal output to minimize vibration measured by such signal output.
